(19) United States
(12) Patent Application Publication
(10) Pub. No.: US 2017/0053638 A1
(43) Pub. Date: Feb. 23, 2017

(54) HYBRID ADAPTIVE NOISE CANCELLATION SYSTEM WITH FILTERED ERROR MICROPHONE SIGNAL

(71) Applicant: Cirrus Logic International Semiconductor Ltd., Edinburgh (GB)

(72) Inventors: Dayong Zhou, Austin, TX (US); Yang Lu, Cedar Park, TX (US); Ning Li, Cedar Park, TX (US); Nitin Kwatra, Austin, TX (US); Antonio J. Miller, Austin, TX (US)

(21) Appl. No.: 14/832,585

(22) Filed: Aug. 21, 2015

(51) Int. Cl. G10K 11/178

(52) U.S. Cl. CPC G10K 11/178; G10K 2210/1082

(57) ABSTRACT

In accordance with systems and methods of the present disclosure, an adaptive noise cancellation system may include an alignment filter configured to correct misalignment of a reference microphone signal and an error microphone signal by generating a misalignment correction signal.

### FIELD OF DISCLOSURE

The present disclosure relates in general to adaptive noise cancellation in connection with an acoustic transducer, and more particularly, to a hybrid adaptive noise cancellation system with a filtered error microphone signal to correct for misalignment between a reference microphone signal and an error microphone signal caused by a feedback filter of the hybrid adaptive noise cancellation system.

### BACKGROUND

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events.

In many noise cancellation systems, it is desirable to include both feedforward noise cancellation by using a feedforward adaptive filter for generating a feedforward anti-noise signal from a reference microphone signal configured to measure ambient sounds and feedback noise cancellation by using a fixed-response feedback filter for generating a feedback noise cancellation signal to be combined with the feedforward anti-noise signal. However, using traditional approaches, when a gain of the feedback path is strong, the response of the feedforward adaptive filter may diverge, thus rendering the adaptive system unstable.

### SUMMARY

In accordance with the teachings of the present disclosure, the disadvantages and problems associated with instability of existing approaches for implementing hybrid adaptive noise cancellation may be reduced or eliminated.

In accordance with embodiments of the present disclosure, a integrated circuit for implementing at least a portion of a personal audio device may include an output for providing a signal to a transducer including both a source audio signal for playback to a listener and an anti-noise signal for countering the effect of ambient audio sounds in an acoustic output of the transducer, a reference microphone input for receiving a reference microphone signal indicative of the ambient audio sounds, an error microphone input for receiving an error microphone signal indicative of the output of the transducer and the ambient audio sounds at the transducer; and a processing circuit. The processing circuit may implement a feedforward filter having a response that generates at least a portion of the anti-noise signal from the reference microphone signal, a secondary path estimate filter configured to model an electro-acoustic path of the source audio signal and have a response that generates a secondary path estimate from the source audio signal, a feedback filter having a response that generates at least a portion of the anti-noise signal based on the error microphone signal, an alignment filter configured to correct misalignment of the reference microphone signal and error microphone signal by generating a misalignment correction signal; a feedforward coefficient control block that shapes the response of the feedforward filter by adapting the response of the feedforward filter to minimize the ambient audio sounds in the error microphone signal; and a secondary path coefficient control block that shapes the response of the secondary path estimate filter in conformity with the source audio signal and the misalignment correction signal in order to minimize the misalignment correction signal.

In accordance with these and other embodiments of the present disclosure, a method for canceling ambient audio sounds in the proximity of a transducer of a personal audio device may include receiving a reference microphone signal indicative of the ambient audio sounds, receiving an error microphone signal indicative of the output of the transducer and the ambient audio sounds at the transducer, generating a source audio signal for playback to a listener, generating a feedforward anti-noise signal component from the reference microphone signal by adapting a response of an adaptive filter that filters the reference microphone signal to minimize the ambient audio sounds in the error microphone signal, generating a feedback anti-noise signal component based on the error microphone signal for countering the effects of ambient audio sounds at an acoustic output of the transducer, generating a misalignment correction signal to correct misalignment of the reference microphone signal and error microphone signal, generating the secondary path estimate from the source audio signal by adapting a response of a secondary path estimate filter that models an electro-acoustic path of the source audio signal and filters the source audio signal to minimize the filtered playback corrected error, and combining the feedforward anti-noise signal component and the feedback anti-noise signal component with a source audio signal to generate an audio signal provided to the transducer.

In accordance with these and other embodiments of the present disclosure, an integrated circuit for implementing at least a portion of a personal audio device may include an output for providing a signal to a transducer including both a source audio signal for playback to a listener and an anti-noise signal for countering the effect of ambient audio sounds in an acoustic output of the transducer, a reference microphone input for receiving a reference microphone signal indicative of the ambient audio sounds, an error microphone input for receiving an error microphone signal indicative of the output of the transducer and the ambient audio sounds at the transducer, a noise input for receiving an injected, substantially inaudible noise signal, and a processing circuit. The processing circuit may implement a feedforward filter having a response that generates at least a portion of the anti-noise signal from the reference microphone signal, a secondary path estimate filter configured to model an electro-acoustic path of the source audio signal and have a response that generates a secondary path estimate from the source audio signal, a feedback filter having a response that generates at least a portion of the anti-noise signal based on the error microphone signal, an effective secondary estimate filter configured to model an electro-acoustic path of the anti-noise signal and have a response that generates the filtered noise signal from the noise signal, a feedforward coefficient control block that shapes the response of the feedforward filter in conformity with the error microphone signal and the reference microphone signal by adapting the response of the feedforward filter to minimize the ambient audio sounds in the error microphone signal, a secondary path coefficient control block that shapes the response of the effective secondary path estimate filter in conformity with the noise signal and the error microphone signal in order to minimize the playback corrected error, and a secondary estimate construction block that generates the response of the secondary estimate filter from the response of the effective secondary estimate filter.

In accordance with these and other embodiments of the present disclosure, a method for canceling ambient audio sounds in the proximity of a transducer of a personal audio device may include receiving a reference microphone signal indicative of the ambient audio sounds, receiving an error microphone signal indicative of an output of the transducer and the ambient audio sounds at the transducer, generating a source audio signal for playback to a listener, generating a feedforward anti-noise signal component from the reference microphone signal by adapting a response of an adaptive filter that filters the reference microphone signal to minimize the ambient audio sounds in the error microphone signal, generating a feedback anti-noise signal component based on the error microphone signal, generating the filtered noise signal from a noise signal by adapting a response of an effective secondary path estimate filter that models an electro-acoustic path of the anti-noise signal and filters the noise signal to minimize the error microphone signal, generating the secondary path estimate from the source audio signal by applying a response of a secondary path estimate filter wherein the response of the secondary estimate filter is generated from the response of the effective secondary estimate filter, and combining the feedforward anti-noise signal component and the feedback anti-noise signal component with a source audio signal to generate an audio signal provided to the transducer.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example wireless mobile telephone, in accordance with embodiments of the present disclosure;

FIG. 1B is an illustration of an example wireless mobile telephone with a headphone assembly coupled thereto, in accordance with embodiments of the present disclosure;

FIG. 2 is a block diagram of selected circuits within the wireless telephone depicted in FIG. 1A, in accordance with embodiments of the present disclosure;

FIGS. 3A-3D are each a block diagram depicting selected signal processing circuits and functional blocks within an example active noise canceling (ANC) circuit of a coder-decoder (CODEC) integrated circuit of FIG. 2, in accordance with embodiments of the present disclosure; and

FIG. 4 is a block diagram depicting selected signal processing circuits and functional blocks within an example active noise canceling (ANC) circuit of a coder-decoder (CODEC) integrated circuit of FIG. 2, in accordance with embodiments of the present disclosure.

### DETAILED DESCRIPTION

The present disclosure encompasses noise canceling techniques and circuits that can be implemented in a personal audio device, such as a wireless telephone. The personal audio device includes an ANC circuit that may measure the ambient acoustic environment and generate a signal that is injected in the speaker (or other transducer) output to cancel ambient acoustic events. A reference microphone may be provided to measure the ambient acoustic environment, and an error microphone may be included for controlling the adaptation of the anti-noise signal to cancel the ambient audio sounds and for correcting for the electro-acoustic path from the output of the processing circuit through the transducer.

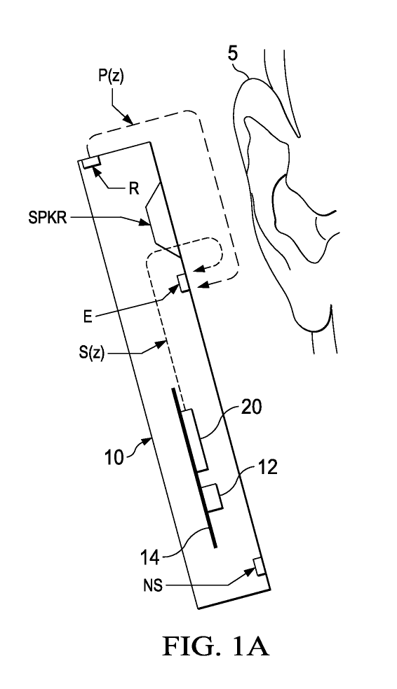

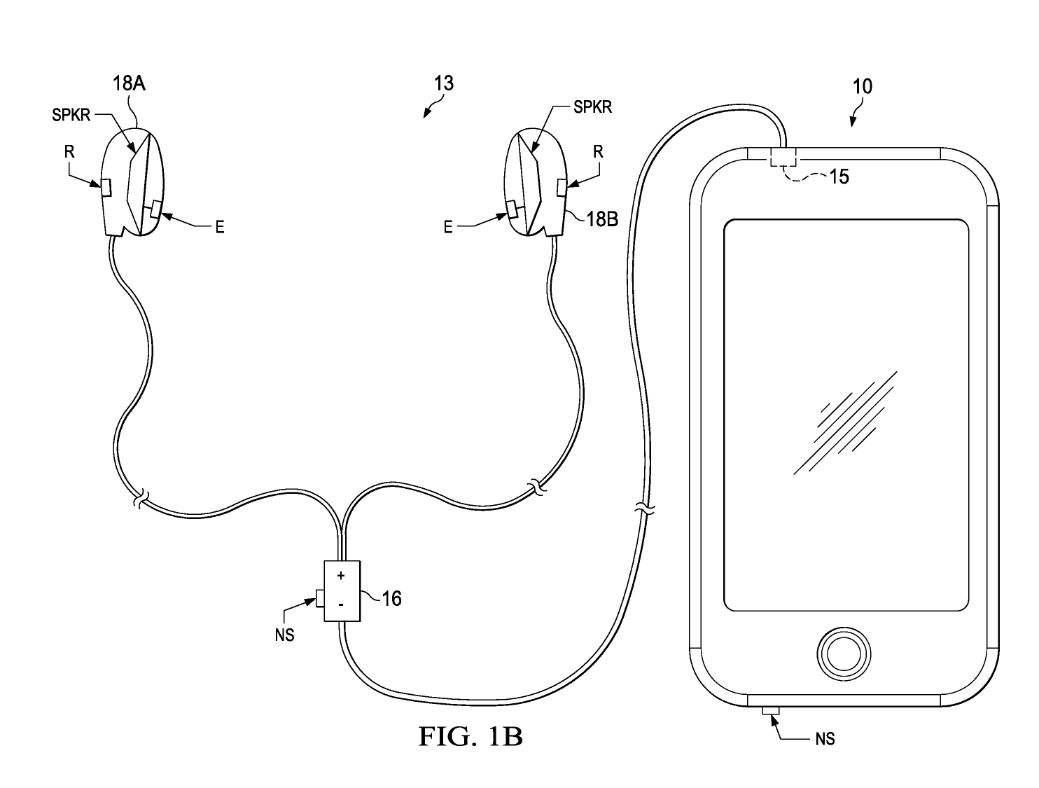

Referring now to FIG. 1A, a wireless telephone 10 as illustrated in accordance with embodiments of the present disclosure is shown in proximity to a human ear 5. Wireless telephone 10 is an example of a device in which techniques in accordance with embodiments of the invention may be employed, but it is understood that not all of the elements or configurations embodied in illustrated wireless telephone 10, or in the circuits depicted in subsequent illustrations, are required in order to practice the invention recited in the claims. Wireless telephone 10 may include a transducer, such as speaker SPKR, that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. A near-speech microphone NS may be provided to capture near-end speech, which is transmitted from wireless telephone 10 to the other conversation participant(s).

Wireless telephone 10 may include ANC circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when wireless telephone 10 is in close proximity to ear 5. In different embodiments, additional reference and/or error microphones may be employed. Circuit 14 within wireless telephone 10 may include an audio CODEC integrated circuit (IC) 20 that receives the signals from reference microphone R, near-speech microphone NS, and error microphone E and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of wireless telephone 10 adapt an anti-noise signal generated from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to wireless telephone 10, when wireless telephone 10 is not firmly pressed to ear 5. While the illustrated wireless telephone 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes.

Referring now to FIG. 1B, wireless telephone 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. As used in this disclosure, the term “headphone” broadly includes any loudspeaker and structure associated therewith that is intended to be mechanically held in place proximate to a listener's ear canal, and includes without limitation earphones, earbuds, and other similar devices. As more specific examples, “headphone,” may refer to intra-concha earphones, supra-concha earphones, and supra-aural earphones.

Combox 16 or another portion of headphone assembly 13 may have a near-speech microphone NS that may capture near-end speech in addition to or in lieu of near-speech microphone NS of wireless telephone 10. In addition, each headphone 18A, 18B may include a transducer, such as speaker SPKR, that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications, such as a low battery indication and other system event notifications. Each headphone 18A, 18B may include a reference microphone R for measuring the ambient acoustic environment and an error microphone E for measuring of the ambient audio combined with the audio reproduced by speaker SPKR close a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

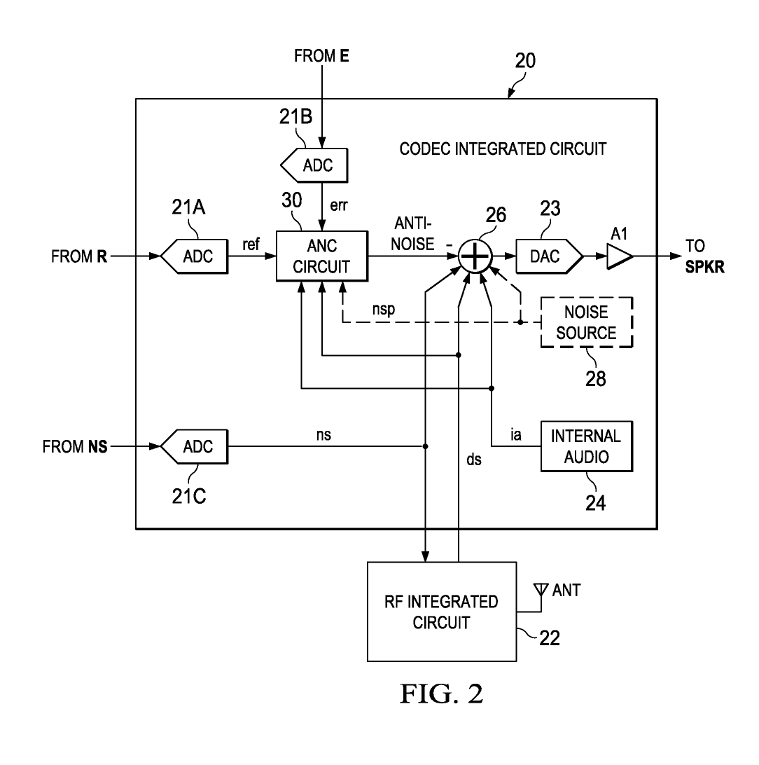

Referring now to FIG. 2, selected circuits within wireless telephone 10 are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals ia from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of wireless telephone 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT. In some embodiments, combiner 26 may also combine a substantially inaudible noise signal nsp (e.g., a noise signal with low magnitude and/or in frequency ranges outside the audible band) generated from a noise source 28.

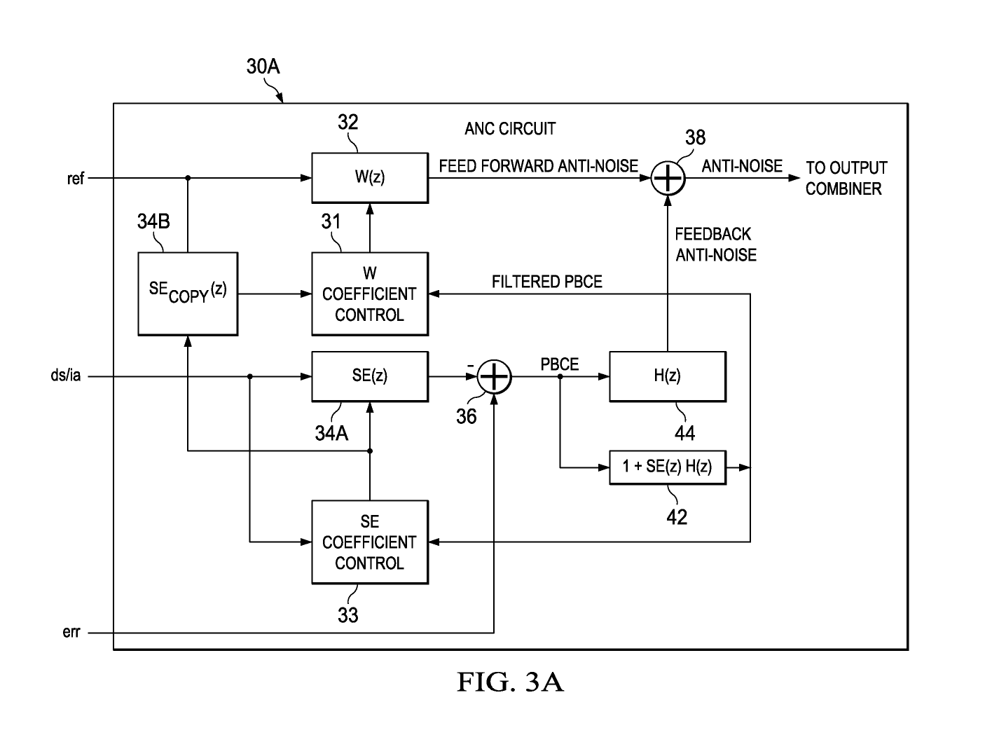

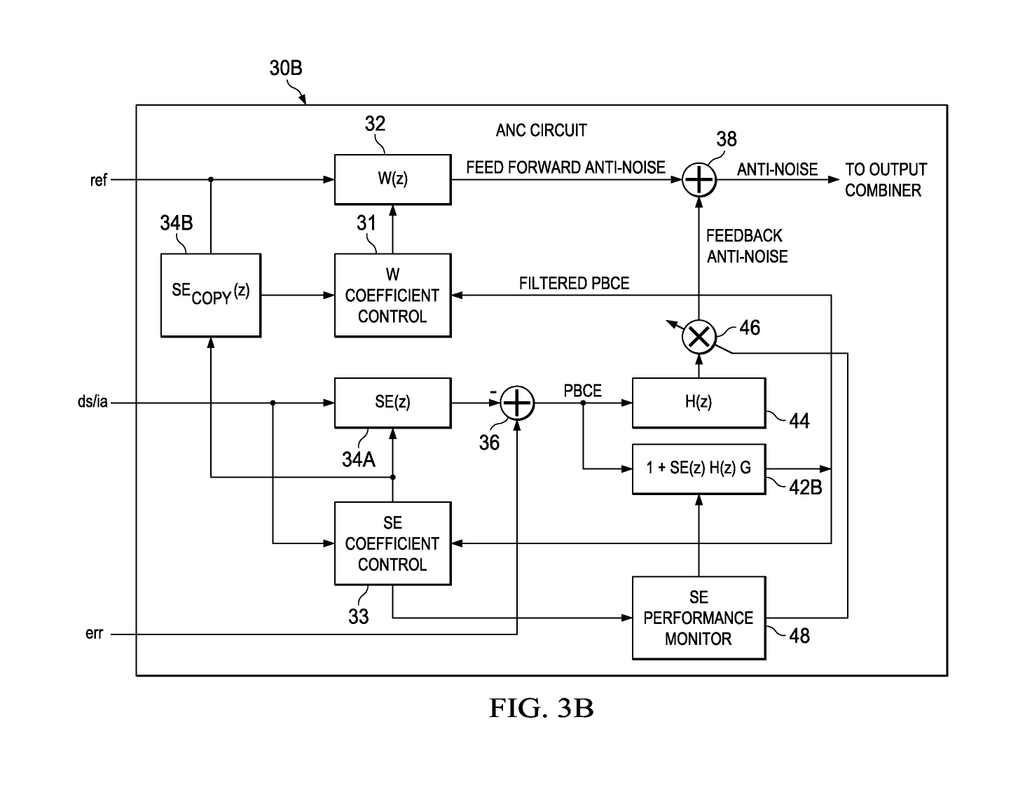

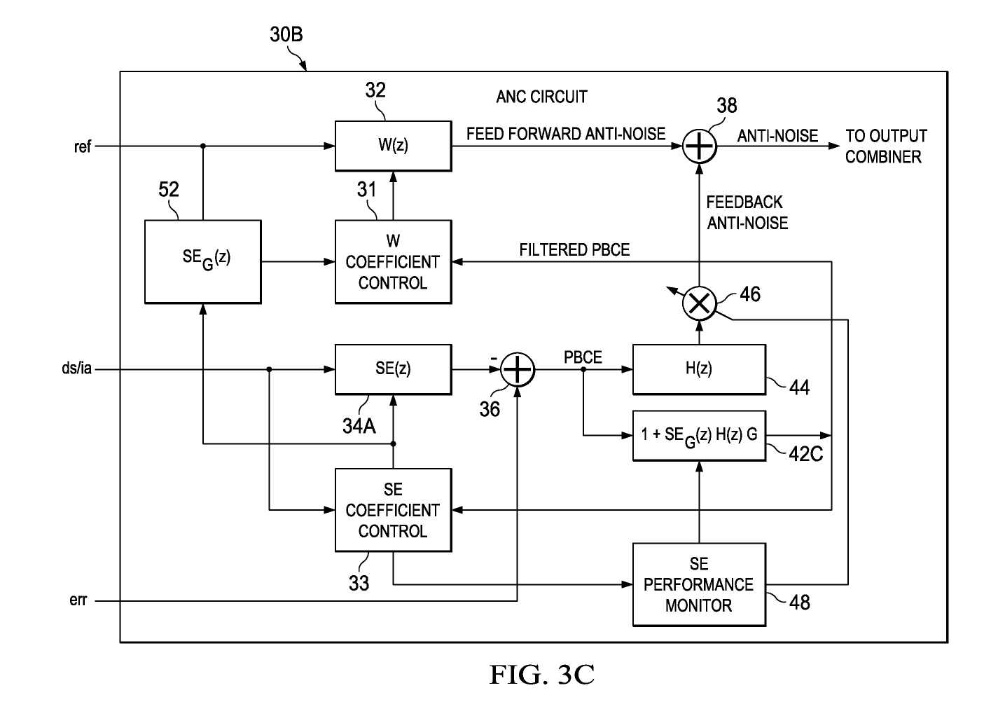

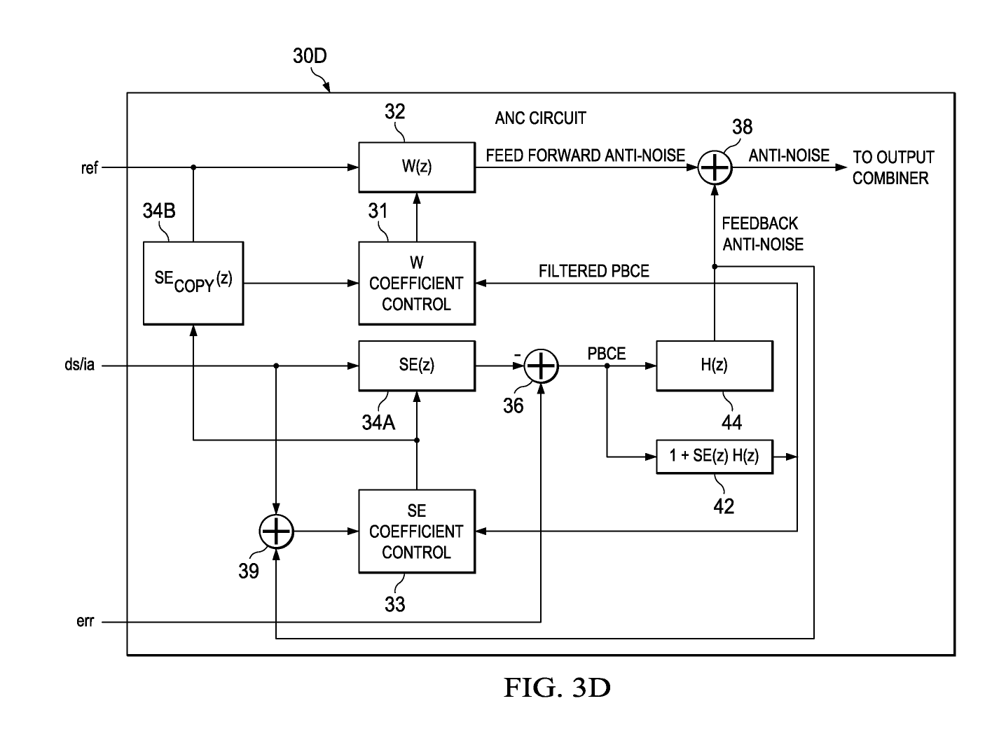

Referring now to FIG. 3A, details of ANC circuit 30A are shown in accordance with embodiments of the present disclosure. ANC circuit 30A may be used in some embodiments to implement ANC circuit 30 depicted in FIG. 2. As shown in FIG. 3A, adaptive filter 32 may receive reference microphone signal ref and under ideal circumstances, may adapt its transfer function W(z) to be P(z)/S(z) to generate a feedforward anti-noise component of the anti-noise signal, which may be combined by combiner 38 with a feedback anti-noise component of the anti-noise signal (described in greater detail below) to generate an anti-noise signal which in turn may be provided to an output combiner that combines the anti-noise signal with the source audio signal to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err as shaped by an alignment filter 42, as described in greater detail below. By transforming reference microphone signal ref with a copy of the estimate of the response of path S(z), response SE_{COPY}(z), and minimizing the ambient audio sounds in the error microphone signal, adaptive filter 32 may adapt to the desired response of P(z)/S(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a copy. By injecting an inverted amount of downlink audio signal ds and/or internal audio signal ia, adaptive filter 32 may be prevented from adapting to the relatively large amount of downlink audio and/or internal audio signal present in error microphone signal err. However, by transforming that inverted copy of downlink audio signal ds and/or internal audio signal ia with the estimate of the response of path S(z), the downlink audio and/or internal audio that is removed from error microphone signal err should match the expected version of downlink audio signal ds and/or internal audio signal ia reproduced at error microphone signal err, because the electrical and acoustical path of S(z) is the path taken by downlink audio signal ds and/or internal audio signal ia to arrive at error microphone E. Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36 to generate a playback-corrected error (shown as PBCE in FIG. 3A) which may be filtered by alignment filter 42 to generate a misalignment correction signal, which may comprise a filtered playback-corrected error, as described in greater detail below. SE coefficient control block 33 may correlate the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

As depicted in FIG. 3A, ANC circuit 30 may also comprise feedback filter 44. Feedback filter 44 may receive the playback corrected error signal PBCE and may apply a response H(z) to generate a feedback anti-noise component of the anti-noise signal based on the playback corrected error which may be combined by combiner 38 with the feedforward anti-noise component of the anti-noise signal to generate the anti-noise signal which in turn may be provided to an output combiner that combines the anti-noise signal with the source audio signal to be reproduced by the transducer, as exemplified by combiner 26 of FIG. 2.

As mentioned above, ANC circuit 30A may also include an alignment filter 42. In the presence of feedback filter 44, an effective secondary path S_{eff}(z) for adaptive filter 32 may be given by S_{eff}(z)=S(z)/[1+H(z)S(z)], and a playback-corrected error PBCE_{FB}(z) with feedback filter 44 present (e.g., H(z)≠0) may be different than a playback-corrected error signal PBCE(z) without feedback filter 44 present (e.g., H(z)=0), as may be given by Err_{FB}=Err(z)/[1+H(z)S(z)]. Accordingly, in the absence of alignment filter 42 (e.g., if playback corrected error PBCE was not filtered by alignment filter 42 and was fed directly into W coefficient control 31 and SE coefficient control 33), the reference microphone signal ref and the playback corrected error PBCE may not be aligned, but may differ by a phase angle of 1/[1+H(z)S(z)]. Thus, alignment filter 42 may be configured to correct such misalignment of reference microphone signal ref, error microphone signal err, the source audio signal, and the playback-corrected error by generating a filtered playback-corrected error (shown as “filtered PBCE” in FIG. 3A) from playback-corrected error PBCE. As shown in FIG. 3A, alignment filter 42 may have a response given by 1+SE(z)H(z).

Referring now to FIG. 3B, details of ANC circuit 30B are shown in accordance with embodiments of the present disclosure. ANC circuit 30B may be used in some embodiments to implement ANC circuit 30 depicted in FIG. 2. ANC circuit 30B may be similar in many respects to ANC circuit 30A, thus only the differences between ANC circuit 30B and ANC circuit 30A are discussed.

As depicted in FIG. 3B, a path of the feedback anti-noise component may have a programmable gain element 46 with a programmable gain G, such that an increased gain G will cause increased noise cancellation of the feedback anti-noise component, and decreasing the gain G will cause reduced noise cancellation of the feedback anti-noise component. Although feedback filter 44 and gain element 46 are shown as separate components of ANC circuit 30B, in some embodiments some structure and/or function of feedback filter 44 and gain element 46 may be combined. For example, in some of such embodiments, an effective gain of feedback filter 44 may be varied via control of one or more filter coefficients of feedback filter 44.

In addition, in ANC circuit 30B, an alignment filter 42B may be implemented in place of alignment filter 42 of ANC circuit 30A, such that alignment filter 42B may have a response 1+SE(z)H(z)G that accounts for any misalignment between reference microphone signal ref and error microphone signal err caused by feedback filter 44 and programmable gain element 46 that would be introduced into ANC circuit 30B if alignment filter 42B were not present (e.g., if playback corrected error PBCE was not filtered by alignment error 42 and was fed directly into W coefficient control 31 and SE coefficient control 33).

As shown in FIG. 3B, ANC circuit 30 may also comprise secondary path estimate performance monitor 48. Secondary path estimate performance monitor 48 may comprise any system, device, or apparatus configured to give an indication of how efficiently secondary path estimate adaptive filter 34A is modeling the electro-acoustic path of the source audio signal over various frequencies, as determined by the efficiency by which secondary path estimate adaptive filter 34A causes combiner 36 to remove the source audio signal from the error microphone signal in generating the playback-corrected error over various frequencies.

Responsive to a determination by a secondary path estimate performance monitor 48 that secondary path estimate adaptive filter 34A is not sufficiently modeling the electro-acoustic path of the source audio signal, secondary path estimate performance monitor 48 may control gain element 46 and alignment filter 42B to reduce gain G, and then increase gain G when secondary path estimate adaptive filter 34A is sufficiently modeling the electro-acoustic path. Thus, when secondary path estimate adaptive filter 34A is not well-trained, secondary path estimate performance monitor 48 may reduce gain G and train secondary path estimate adaptive filter 34A. Once secondary path estimate adaptive filter 34A is well-trained, secondary path estimate performance monitor 48 may increase gain G and then update secondary path estimate adaptive filter 34A and/or adaptive filter 32.

To determine whether or not secondary path estimate adaptive filter 34A is not sufficiently modeling the electro-acoustic path of the source audio signal, secondary path estimate performance monitor 48 may calculate a secondary index performance index (SEPI) defined as:

SEPI=Σᵢ₌ₖⁿ|SE(i)|

where k represents a first coefficient tap of secondary path estimate adaptive filter 34A and n represents a second coefficient tap of secondary path estimate adaptive filter 34A. In some embodiments, the coefficient taps will comprise the coefficient taps representing the longest delay elements of a finite impulse response filter that implements secondary path estimate adaptive filter 34A. For example, in a 256-coefficient filter, k may equal 128 and n may equal 256. Once calculated, the value of SEPI may be compared to one or more threshold values to determine if secondary path estimate adaptive filter 34A is sufficiently modeling the electro-acoustic path of the source audio signal. If the SEPI value is below such a threshold, secondary path estimate adaptive filter 34A may be determined to be sufficiently modeling the electro-acoustic path of the source audio signal

Referring now to FIG. 3C, details of ANC circuit 30C are shown in accordance with embodiments of the present disclosure. ANC circuit 30C may be used in some embodiments to implement ANC circuit 30 depicted in FIG. 2. ANC circuit 30C may be similar in many respects to ANC circuit 30B, thus only the differences between ANC circuit 30C and ANC circuit 30B are discussed.

As shown in FIG. 3C, alignment filter 42C may be used in lieu of alignment filter 42B shown in FIG. 3B, wherein the difference is that alignment filter 42C may apply a response 1+SE_{G}(z)H(z)G, which represents a previously-stored known-good response of secondary path estimate adaptive filter 34A existing at a time when, as determined by secondary path estimate performance monitor 48, secondary path estimate filter 34A was sufficiently modeling the electro-acoustic path of the source audio signal. In addition, filter 34B may be replaced by a filter 52 having a response SE_{G}(z).

In operation, when secondary path estimate performance monitor 48 determines that secondary path estimate filter 34A is sufficiently modeling the electro-acoustic path of the source audio signal, secondary path estimate performance monitor 48 may cause the response SE_{G}(z) to be updated with the response SE(z) on a periodic basis. On the other hand, when secondary path estimate performance monitor 48 determines that secondary path estimate filter 34A is not sufficiently modeling the electro-acoustic path of the source audio signal, secondary path estimate performance monitor 48 may freeze the update of SE_{G}(z). In some embodiments, whenever the response SE_{G}(z) is to be updated, smoothing or cross-fading may be applied to transition the response SE_{G}(z) from its current response to its updated response.

In addition, in some embodiments, secondary path estimate performance monitor 48 may update response SE_{G}(z) at an update frequency dependent upon a value of SEPI. For example, if SEPI is below a first threshold value, secondary path estimate performance monitor 48 may cause response SE_{G}(z) to update at a first update frequency. If SEPI is above the first threshold value but below a second threshold value, secondary path estimate performance monitor 48 may cause response SE_{G}(z) to update at a second update frequency which is lesser than the first update frequency. If SEPI is above the second threshold value, secondary path estimate performance monitor 48 may cause response SE_{G}(z) to cease updating.

Referring now to FIG. 3D, details of ANC circuit 30D are shown in accordance with embodiments of the present disclosure. ANC circuit 30D may be used in some embodiments to implement ANC circuit 30 depicted in FIG. 2. ANC circuit 30D may be similar in many respects to ANC circuit 30A, thus only the differences between ANC circuit 30D and ANC circuit 30A are discussed.

As depicted in FIG. 3D, instead of SE coefficient control block 33 adaptively updating response SE(z) based on a correlation between a source audio signal (e.g., downlink audio signal ds and/or internal audio signal ia) and the filtered playback corrected error as shown in FIG. 3A, a combiner 39 may combine the source audio signal ds/ia with the feedback anti-noise to generate a modified source audio signal that is communicated to SE coefficient control block 33 such that SE coefficient control block 33 adaptively updates response SE(z) based on a correlation between the modified source audio signal and the filtered playback corrected error. The modified source audio signal (ds/ia)_{mod} may be given by the equation:

$${( ds / ia )}_{mod} = ( ds / ia ) \frac{1 + H ( z ) SE ( z )}{1 + H ( z ) S ( z )}$$

Thus, if secondary response SE(z) closely tracks the actual secondary response S(z), then the modified source audio signal will approximately equal the unmodified source audio signal.

The approach set forth in FIG. 3D may be used in lieu of adjusting gain G as shown in FIGS. 3B and 3C. The approach set forth in FIG. 3D may guarantee phase alignment between reference microphone signal ref and error microphone signal err for the secondary estimate filter 34A, which may in turn assure convergence of the response SE(z) for small step sizes. However, the response SE(z) may be a biased estimation of response S(z) when the signal-to-noise ratio of ANC circuit 30D is low. Accordingly, the approach set forth in FIG. 3D may be best suited for when signal-to-noise ratio is high.

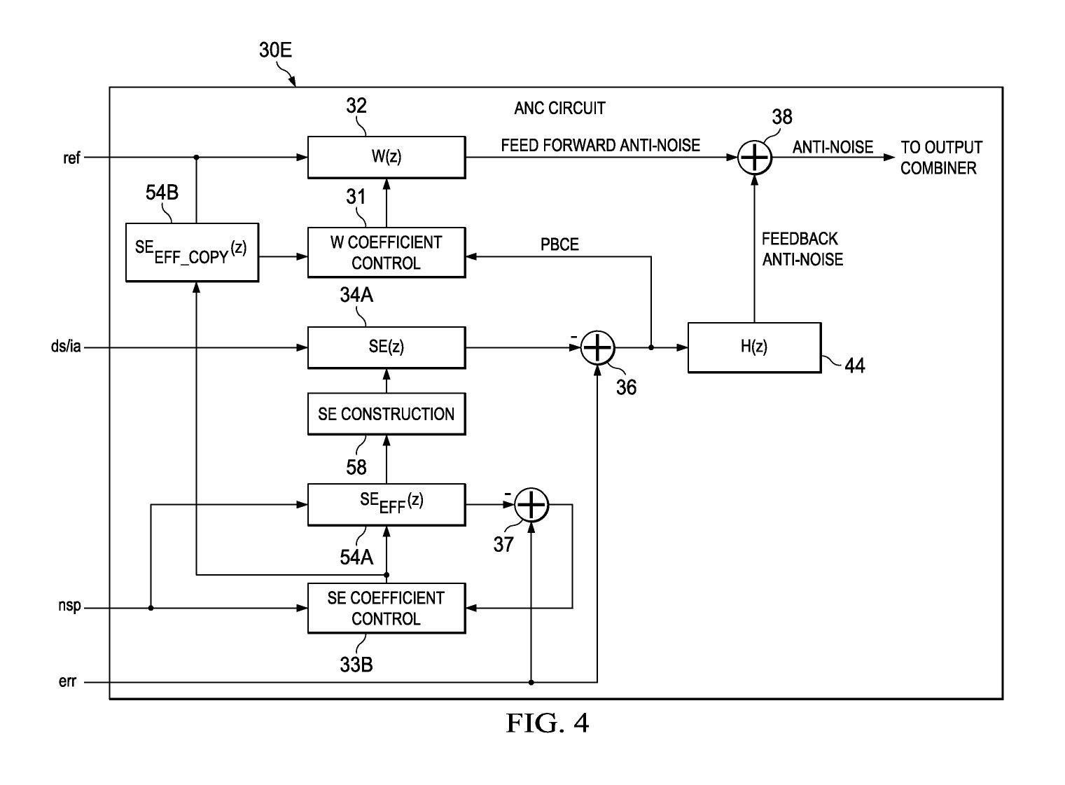

Referring now to FIG. 4, details of ANC circuit 30E are shown in accordance with embodiments of the present disclosure. ANC circuit 30E may be used in some embodiments to implement ANC circuit 30 depicted in FIG. 2. As shown in FIG. 4, adaptive filter 32 may receive reference microphone signal ref and under ideal circumstances, may adapt its transfer function W(z) to be P(z)/S(z) to generate a feedforward anti-noise component of the anti-noise signal, which may be combined by combiner 38 with a feedback anti-noise component of the anti-noise signal (described in greater detail below) to generate an anti-noise signal which in turn may be provided to an output combiner that combines the anti-noise signal with the source audio signal to be reproduced by the transducer, as exemplified by combiner 26 of FIG. 2. Therefore, response W(z) may be adapted to P(z)/S_{eff}(z) due to the existence of feedback filter 44. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 54B and another signal that includes a playback corrected error signal PBCE which is generated from error microphone signal err. As described previously, an effective secondary path S_{eff}(z) for adaptive filter 32 may be given by S_{eff}(z)=S(z)/[1+H(z)S(z)], and the response of filter 54B may be SE_{eff}_{_}_{COPY}(z), which is a copy of a response S_{eff}(z) of an adaptive effective secondary estimate filter 54A, which is described in greater detail below.

By transforming reference microphone signal ref with a copy of the estimate of the effective response of path S(z), response SE_{eff}_{_}_{COPY}(z), and minimizing the ambient audio sounds in the error microphone signal, adaptive filter 32 may adapt to the desired response of P(z)/S_{eff}(z). In addition to error microphone signal err, the signal compared to the output of filter 34B by W coefficient control block 31 may include an inverted amount of downlink audio signal ds and/or internal audio signal ia that has been processed by a filter response SE(z). Filter 54B may not be an adaptive filter, per se, but may have an adjustable response that is tuned to match the response of adaptive filter 54A, so that the response of filter 54B tracks the adapting of adaptive filter 54A.

To implement the above, adaptive filter 54A may have coefficients controlled by SE coefficient control block 33B, which may compare an injected, substantially inaudible noise signal nsp and error microphone signal err after removal by combiner 37 of noise signal nsp that has been filtered by adaptive filter 54A having response SE(z) to represent the expected noise signal nsp delivered to error microphone E. Thus, SE coefficient control block 33B may correlate the noise signal nsp with the components of noise signal nsp that are present in error microphone signal err in order to generate response SE_{eff}(z) of adaptive filter 54A to minimize the error microphone signal.

Downlink audio signal ds and/or internal audio signal may be filtered by secondary estimate filter 34A having response SE(z). The filtered downlink audio signal ds and/or internal audio signal may be subtracted from error signal err by a combiner 36 to generate a playback-corrected error (shown as PBCE in FIG. 4).

Furthermore, in order to generate response SE(z) of adaptive filter 34A, an SE construction block 58 may determine response SE(z) from response SE_{eff}(z). For example, SE construction block 58 may calculate response SE(z) in accordance with the following equation:

$$SE ( z ) = \frac{{SE}_{eff} ( z )}{1 - H ( z ) {SE}_{eff} ( z )}$$

For example, in order to implement a filter that has a response as in the foregoing equation, one may construct a finite impulse response filter directly using the frequency response of terms on the right side of the equation. As another example, one may construct a filter with such a response using several finite impulse response and/or infinite impulse response blocks.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An integrated circuit for implementing at least a portion of a personal audio device, comprising:
an output for providing a signal to a transducer including both a source audio signal for playback to a listener and an anti-noise signal for countering an effect of ambient audio sounds in an acoustic output of the transducer;
a reference microphone input for receiving a reference microphone signal indicative of the ambient audio sounds;
an error microphone input for receiving an error microphone signal indicative of the output of the transducer and the ambient audio sounds at the transducer; and
a processing circuit that implements:
a feedforward filter having a response that generates at least a portion of the anti-noise signal from the reference microphone signal;
a secondary path estimate filter configured to model an electro-acoustic path of the source audio signal and have a response that generates a secondary path estimate from the source audio signal;
a feedback filter having a response that generates at least a portion of the anti-noise signal based on the error microphone signal;
an alignment filter configured to correct misalignment of the reference microphone signal and error microphone signal by generating a misalignment correction signal;
a feedforward coefficient control block that shapes the response of the feedforward filter by adapting the response of the feedforward filter to minimize the ambient audio sounds in the error microphone signal; and
a secondary path coefficient control block that shapes the response of the secondary path estimate filter in conformity with the source audio signal and the misalignment correction signal in order to minimize the misalignment correction signal.

2. The integrated circuit of claim 1, wherein the response of the feedback filter generates at least the portion of the anti-noise signal from a playback corrected error, the playback corrected error based on a difference between the error microphone signal and the secondary path estimate.

3. The integrated circuit of claim 2, wherein the misalignment correction signal comprises a filtered playback corrected error generated from the playback corrected error.

4. The integrated circuit of claim 3, wherein the feedforward control block shapes the response of the feedforward filter in conformity with the filtered playback corrected error and the reference microphone signal.

5. The integrated circuit of claim 1, wherein the alignment filter has a response given by 1+SE(z)H(z), where SE(z) is the response of the secondary path estimate filter and H(z) is the response of the feedback filter.

6. The integrated circuit of claim 1, wherein the processing circuit further implements a gain associated with the feedback filter.

7. The integrated circuit of claim 6, wherein the processing circuit further implements a secondary path estimate performance monitor for monitoring performance of the secondary path estimate filter in modeling the electro-acoustic path.

8. The integrated circuit of claim 7, wherein the processing circuit controls the gain responsive to the secondary path estimate performance monitor.

9. The integrated circuit of claim 8, wherein the alignment filter has a response given by 1+SE(z)H(z)G, where SE(z) is the response of the secondary path estimate filter, H(z) is the response of the feedback filter, and G is the gain.

10. The integrated circuit of claim 8, wherein the alignment filter has a response given by 1+SE_{G}(z)H(z)G, where SE_{G}(z) is a previously-stored response of the secondary path estimate filter existing at a time when, as determined by the secondary path estimate performance monitor, the secondary path estimate filter was sufficiently modeling the electro-acoustic path of the source audio signal, H(z) is the response of the feedback filter, and G is the gain.

11. The integrated circuit of claim 10, wherein the secondary path estimate performance monitor updates the stored response SE_{G}(z) at an update frequency dependent upon a degree of which the secondary path estimate filter is sufficiently modeling the electro-acoustic path of the source audio signal.

12. The integrated circuit of claim 10, wherein a filter having a response substantially equivalent to SE_{G}(z) is applied to the reference microphone signal to generate a filtered reference microphone signal communicated to the feedforward coefficient control block.

13. The integrated circuit of claim 1, wherein the secondary path coefficient control block shapes the response of the secondary path estimate filter by correlating the misalignment correction signal and a modified source audio signal in order to minimize the misalignment correction signal, wherein the modified source audio signal comprises the sum of the source audio signal and a portion of the anti-noise signal generated by the feedback filter.

14. A method for canceling ambient audio sounds in a proximity of a transducer of a personal audio device, the method comprising:
receiving a reference microphone signal indicative of the ambient audio sounds;
receiving an error microphone signal indicative of the output of the transducer and the ambient audio sounds at the transducer;
generating a source audio signal for playback to a listener;
generating a feedforward anti-noise signal component from the reference microphone signal by adapting a response of an adaptive filter that filters the reference microphone signal to minimize the ambient audio sounds in the error microphone signal;
generating a feedback anti-noise signal component based on the error microphone signal, for countering the effects of ambient audio sounds at an acoustic output of the transducer;
generating a misalignment correction signal to correct misalignment of the reference microphone signal and error microphone signal;
generating the secondary path estimate from the source audio signal by adapting a response of a secondary path estimate filter that models an electro-acoustic path of the source audio signal and filters the source audio signal to minimize the filtered playback corrected error; and
combining the feedforward anti-noise signal component and the feedback anti-noise signal component with a source audio signal to generate an audio signal provided to the transducer.

15. The method of claim 14, wherein generating the feedback anti-noise signal component comprises filtering a playback corrected error with a feedback filter, the playback corrected error based on a difference between the error microphone signal and a secondary path estimate

16. The method of claim 15, wherein generating the misalignment correction signal comprises generating a filtered playback corrected error from the playback corrected error.

17. The method of claim 16, wherein adapting the response of an adaptive filter that filters the reference microphone signal comprises shaping the response of the adaptive filter in conformity with the filtered playback corrected error and the reference microphone signal.

18. The method of claim 14, wherein the alignment filter has a response given by 1+SE(z)H(z), where SE(z) is the response of the secondary path estimate filter and H(z) is the response of the feedback filter.

19. The method of claim 14, further comprising applying a gain associated with the feedback filter.

20. The method of claim 19, further comprising monitoring with a secondary path estimate performance to monitor performance of the secondary path estimate filter in modeling the electro-acoustic path.

21. The method of claim 20, further comprising controlling a gain of the gain element responsive to the secondary path estimate performance monitor.

22. The method of claim 20, wherein the alignment filter has a response given by 1+SE(z)H(z)G, where SE(z) is the response of the secondary path estimate filter, H(z) is the response of the feedback filter, and G is the gain.

23. The method of claim 20, wherein the alignment filter has a response given by 1+SE_{G}(z)H(z)G, where SE_{G}(z) is a previously-stored response of the secondary path estimate filter existing at a time when, as determined by the secondary path estimate performance monitor, the secondary path estimate filter was sufficiently modeling the electro-acoustic path of the source audio signal, H(z) is the response of the feedback filter, and G is the gain.

24. The method of claim 23, further comprising updating the stored response SE_{G}(z) at an update frequency dependent upon a degree of which the secondary path estimate filter is sufficiently modeling the electro-acoustic path of the source audio signal.

25. The method of claim 23, further comprising applying a filter having a response substantially equivalent to SE_{G}(z) to the reference microphone signal to generate a filtered reference microphone signal communicated to the feedforward coefficient control block.

26. The method of claim 14, wherein the secondary path coefficient control block shapes the response of the secondary path estimate filter by correlating the misalignment correction signal and a modified source audio signal in order to minimize the misalignment correction signal, wherein the modified source audio signal comprises the sum of the source audio signal and a portion of the anti-noise signal generated by the feedback filter.

27. An integrated circuit for implementing at least a portion of a personal audio device, comprising:
an output for providing a signal to a transducer including both a source audio signal for playback to a listener and an anti-noise signal for countering an effect of ambient audio sounds in an acoustic output of the transducer;
a reference microphone input for receiving a reference microphone signal indicative of the ambient audio sounds;
an error microphone input for receiving an error microphone signal indicative of the output of the transducer and the ambient audio sounds at the transducer;
a noise input for receiving an injected, substantially inaudible noise signal; and
a processing circuit that implements:
a feedforward filter having a response that generates at least a portion of the anti-noise signal from the reference microphone signal;
a secondary path estimate filter configured to model an electro-acoustic path of the source audio signal and have a response that generates a secondary path estimate from the source audio signal;
a feedback filter having a response that generates at least a portion of the anti-noise signal based on the error microphone signal;
an effective secondary estimate filter configured to model an electro-acoustic path of the anti-noise signal and have a response that generates a filtered noise signal from the noise signal;
a feedforward coefficient control block that shapes the response of the feedforward filter in conformity with the error microphone signal and the reference microphone signal by adapting the response of the feedforward filter to minimize the ambient audio sounds in the error microphone signal;
a secondary path coefficient control block that shapes the response of the effective secondary path estimate filter in conformity with the noise signal and the error microphone signal in order to minimize the error signal; and
a secondary estimate construction block that generates the response of the secondary estimate filter from the response of the effective secondary estimate filter.

28. The integrated circuit of claim 27, wherein the secondary estimate construction block generates the response of the secondary estimate filter from the response of the effective secondary estimate filter in accordance with the equation:
$$SE ( z ) = \frac{{SE}_{eff} ( z )}{1 - H ( z ) {SE}_{eff} ( z )}$$
where SE(z) is the response of the secondary estimate filter, SE_{eff}(z) is the response of the effective secondary estimate filter, and H(z) is the response of the feedback filter.

29. The integrated circuit of claim 27, wherein the response of the feedback filter generates at least the portion of the anti-noise signal from a playback corrected error, the playback corrected error based on a difference between the error microphone signal and a sum of the secondary path estimate and a filtered noise signal.

30. A method for canceling ambient audio sounds in the proximity of a transducer of a personal audio device, the method comprising:
receiving a reference microphone signal indicative of the ambient audio sounds;
receiving an error microphone signal indicative of an output of the transducer and the ambient audio sounds at the transducer;
generating a source audio signal for playback to a listener;
generating a feedforward anti-noise signal component from the reference microphone signal by adapting a response of an adaptive filter that filters the reference microphone signal to minimize the ambient audio sounds in the error microphone signal;
generating a feedback anti-noise signal component based on the error microphone signal;
generating the filtered noise signal from a noise signal by adapting a response of an effective secondary path estimate filter that models an electro-acoustic path of the anti-noise signal and filters the noise signal to minimize the error microphone signal;
generating the secondary path estimate from the source audio signal by applying a response of a secondary path estimate filter wherein the response of the secondary estimate filter is generated from the response of the effective secondary estimate filter; and
combining the feedforward anti-noise signal component and the feedback anti-noise signal component with a source audio signal to generate an audio signal provided to the transducer.

31. The method of claim 30, wherein a secondary estimate construction block generates the response of the secondary estimate filter from the response of the effective secondary estimate filter in accordance with the equation:
$$SE ( z ) = \frac{{SE}_{eff} ( z )}{1 - H ( z ) {SE}_{eff} ( z )}$$
where SE(z) is the response of the secondary estimate filter, SE_{eff}(z) is the response of the effective secondary estimate filter, and H(z) is the response of the feedback filter.

32. The method of claim 30, wherein generating the feedback anti-noise signal component comprises filtering a playback corrected error with a feedback filter, the playback corrected error based on a difference between the error microphone signal and a sum of a secondary path estimate and a filtered noise signal.
